(19) United States
(12) Patent Application Publication
(10) Pub. No.: US 2014/0279867 A1
(43) Pub. Date: Sep. 18, 2014

(54) METHOD AND APPARATUS FOR PROVIDING REAL TIME TELEVISION LISTINGS FOR VENUES

(71) Applicant: AMI Entertainment Network, LLC, Trevose, PA (US)

(72) Inventor: Augustus John RUSSO, Blue Bell, PA (US)

(73) Assignee: AMI Entertainment Network, LLC, Trevose, PA (US)

(21) Appl. No.: 14/210,734

(22) Filed: Mar. 14, 2014

Related U.S. Application Data
(60) Provisional application No. 61/784,225, filed on Mar. 14, 2013.

(51) Int. Cl. G06F 17/30

(52) U.S. Cl. CPC G06F 17/30528
USPC 707/609

(57) ABSTRACT

A system for disseminating venue-specific content output information to users is described. A venue database stores a plurality of venue entries associated with a respective plurality of venues. Each venue entry includes information identifying one or more content output devices deployed thereat. A controller is communicatively coupled to the content output devices by a first network. The controller is configured to receive, over the first network, from the content output devices, identifying information associated with the content being output by the respective content output devices deployed at the plurality of venues. The controller also updates the venue entries stored in the venue database with the received identifying information of content being output by the content output devices deployed at the respective venues. A server is accessible by computing devices of users over a second network to retrieve the identification information stored in the venue database.

### CROSS-REFERENCE TO RELATED APPLICATION

This application claims the benefit of U.S. Provisional Application No. 61/784,225, filed Mar. 14, 2013.

### FIELD OF THE INVENTION

Embodiments of the present invention relate generally to providing real-time listings of content being displayed by electronic devices deployed at venues.

### BACKGROUND OF THE INVENTION

Venues, such as bars, restaurants, casinos, and the like, often supplement their services by providing multimedia content for the enjoyment of patrons. Outputting content that is relevant to patrons of a venue encourages patrons to remain at the venue for longer periods of time, thereby allowing the venue to increase per-patron revenue. Furthermore, outputting desirable content can often attract new and repeat patrons to a venue. For example, a sports bar may show a sporting contest of an out-of-market sports team or club in order to attract local and/or visiting fans of that team to the venue. Similarly, showing a Pay-Per-View boxing match can attract patrons to visit a venue that they may not ordinarily visit.

Such content is typically output on display devices deployed at the venues. Such display devices include televisions, projectors, computer monitors, and the like. Typically, a content output device, such as a computer, set-top box, BLU-RAY player, DVD player, or media-streaming device, is communicatively coupled to the display device. The content output device receives and/or reads the content from a medium or network such as the Internet, a cable television network, a satellite feed, or an optical or mass storage medium.

In order to present content to patrons, venues typically subscribe to one or more content packages offered by content providers. These content providers offer a wide range of content in various categories, channels, and genres that may be displayed to venue patrons in real time, or recorded and played back at a later time.

Venue personnel often advertise content that is being presented. or that is scheduled to be presented, at the venue in order to attract patrons to the venue. Venue personnel typically manually manage such advertisements using, for example, in-venue advertising, such as bulletin boards or voice announcements, or online advertising through their websites and social media sites such as TWITTER, FACEBOOK and the like. Due to its decentralized nature, the information must be actively managed and updated by venue personnel and is not easily accessible to prospective venue patrons. Furthermore, it is difficult for prospective venue patrons to search for venues based upon what multimedia content they are showing or plan to be showing at a particular time.

Accordingly, it is desirable to provide an easily accessible, centralized, information source for substantially real time information about multimedia content being output at venues. More particularly, it is desirable to allow prospective patrons to review listings of television programming being played at venues of interest over a network such as the Internet.

### SUMMARY OF THE INVENTION

In one embodiment, a system for disseminating venue-specific content output information to users is described. A venue database stores a plurality of venue entries associated with a respective plurality of venues. Each venue entry includes information identifying one or more content output devices deployed thereat. A controller is communicatively coupled to the content output devices by a first network. The controller is configured to receive, over the first network, from the content output devices, identifying information associated with the content being output by the respective content output devices deployed at the plurality of venues. The controller also updates the venue entries stored in the venue database with the received identifying information of content being output by the content output devices deployed at the respective venues. A server is accessible by computing devices of users over a second network to retrieve the identification information stored in the venue database.

In another embodiment, a system for disseminating venue-specific television programming information to users is described. A venue database stores a plurality of venue entries associated with a respective plurality of venues. Each venue entry includes information identifying one or more set-top boxes deployed thereat. Each of the set-top boxes is configured to output content to users at the venue through respective communicatively coupled display devices. A controller is communicatively coupled to the set-top boxes by a first network. The controller receives, over the first network, from the set-top boxes, identifying information associated with the content being output by the respective set-top boxes deployed at the plurality of venues, and causes the venue entries stored in the venue database to be updated with the received identifying information of content being output by set-top boxes deployed at the respective venues. A server is accessible by computing devices of users over a second network to retrieve the identification information stored in the venue database. The identification information allows the respective users to determine content currently being output at venues of interest to them prior to physically visiting the venues of interest.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown.

FIG. 1 is a system diagram of a content information system having a plurality of venues with deployed content output devices according to the preferred embodiment of the present invention;

FIG. 2 is a system diagram of the content information system of FIG. 1 with a venue having a venue controller communicatively coupled to a plurality of content output devices;

FIG. 3 is a flowchart of steps for registering a venue and updating content output listings according to the preferred embodiment of the present invention;

FIG. 4A is a flowchart of steps for updating content output schedule information according to the preferred embodiment of the present invention;

FIG. 4B is a flowchart of steps for updating content listings for content currently being presented according to the preferred embodiment of the present invention;

FIG. 5 is a flowchart of steps for retrieving venue-specific content output information according to the preferred embodiment of the present invention;

FIG. 6 is a flowchart of steps for retrieving venues showing desired content according to the preferred embodiment of the present invention;

FIG. 7 is a sequence diagram of communications for registering and updating content output devices according to the preferred embodiment of the present invention;

FIG. 8 is a sequence diagram of communications for retrieving venue-specific content listings according to the preferred embodiment of the present invention; and

FIG. 9 is a sequence diagram of communications for retrieving venues showing desired content according to the preferred embodiment of the present invention.

### DETAILED DESCRIPTION OF THE PREFERRED EMBODIMENTS

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

The present disclosure relates to providing content output listings for content output devices deployed at venues. Content output listings may be for any kind of multimedia content being displayed or shown at a venue, whether live or previously recorded. For example, content output may be television programming such as a live sporting event, awards show, or the like. Entertainment content may also be previously recorded television shows or movies being shown on a particular television channel or streamed from a service such as NETFLIX.

Referring to the drawings in detail, wherein like reference numerals indicate like elements throughout, FIG. 1 is a system diagram of a content output information system according to a preferred embodiment of the present invention. A venue information server system 100 is connected by a network 110 to electronic devices deployed at a plurality of venues 120A, 120B, 120C. The network 110 is preferably comprises portions of a wide area network, such as the Internet. The venue information server system 100 may be implemented by any combination of computing devices, including one or more physical or virtual servers. The venue information server system 100 preferably implements an N-tier server infrastructure having one or more application servers, one or more web servers, and the like.

Each venue 120 preferably has a plurality of content output devices (“COD”) 130 that output content to one or more communicatively coupled display devices 140. The COD 130 may be any device capable of receiving and/or reading multimedia content, and outputting the multimedia content to a display device 140. For example, the CODs 130 may be digital receivers, computer devices, multimedia streaming devices such as APPLETV and BOXEE BOX, cable television set-top boxes, satellite television receivers, TIVO, SLINGBOX, and the like. The display devices 140 may be any electronic devices capable of outputting multimedia content to one or more patrons of the venue, such as televisions, projectors, monitors, and the like. It is to be understood that while CODs 130 and display devices 140 are described as separate devices, their functions may be combined within a single housing or device within the scope of the invention.

Preferably, each venue 120 includes one or more CODs 130, each COD 130 connected to one or more display devices 140. In the preferred embodiment, there is no limit to the number of CODs 130 and display devices 140 that may be deployed at any particular venue. For example, a sports bar may wish to show each NFL football game on a particular game day, and would therefore need ten or more content output devices and corresponding display devices to present all of the games being played simultaneously. Furthermore, each COD 130 may output to more than one display device 140, therefore there may be substantially more display devices 140 than CODs 130 deployed at any particular venue.

In the exemplary embodiment of FIG. 1, the first venue 120a includes two CODs 130a and 130b. The first COD 130a is connected to two different display devices 140. The second COD 130b is connected to only a single display device 140. However, each of the CODs can be connected to any number of display devices 140. Similarly, the second venue 120b includes only a single COD 130c connected to a single display device 140. A plurality of other venues 120c also include various combinations of CODs 130 and display devices 140.

Referring to FIG. 2, according to one embodiment, at least some of the venues 120 include a venue controller 200 that is communicatively coupled to the CODs 130 deployed at the venue 120 by a local network 205. The venue controller 200 preferably provides a centralized graphical user interface (not shown) for controlling the plurality of CODs 130 deployed at the venue. The venue controller 200 allows venue personnel to change the content output settings (e.g., channel change, volume change, audio source change, and the like) for one or more CODs 130 deployed at the venue 120. In one preferred embodiment, the venue controller 200 is the TAP.tv controller from AMI ENTERTAINMENT NETWORK.

The venue controller 200 serves as the intermediary between the CODs 130 deployed at the venue 120 and the venue information server system 100 by aggregating data from the CODs 130 deployed at the venue 120 over the local network 205. The venue controller 200 transmits the aggregated data over the network 110 to the venue information server system 100. It should be understood that not all venues 120 must have a venue controller 200. CODs 130 deployed at venues 120 that do not have a deployed venue controller 200 may individually communicate with the venue information server system 100 over the network 110.

The venue information server system 100 includes a venue information database 105a storing entries for each of a plurality of registered venues 120. The venue information database 105a stores information identifying the CODs 130 deployed at each of the registered venues 120, for example, by a serial number, MAC address, or the like. Optionally, the venue information database 105a also stores information identifying the display devices 140 deployed at each of the registered venues 120. A content listings database 105b is communicatively coupled to the venue information server system 100. In one embodiment, the content listings database 105b and the venue information database 105a are a single database. Preferably, the content listings database 105b stores information about content that is playing, is scheduled to be played, or can be played at the venues 120.

FIG. 3 is a flowchart showing steps for registering venues 120 having CODs 130 with the venue information server system 100. At step 300, the venue information server system 100 receives a registration request from a venue 120. The registration request may be a manual request to input a new venue 120, or a dynamic request, such as a request transmitted by a deployed venue controller 200 or COD 130. The request preferably includes information identifying the name and geographic location of the venue, and any other information necessary to register the venue, such as login and password information. At step 310, the venue information server system 100 identifies the COD(s) 130, venue controller(s) 200, and optionally, display device(s) 140 deployed at the venue associated with the registration request. The venue information server system 100 creates and/or updates the venue's database entry in the venue information database 105a and creates and/or updates the information regarding electronic devices (CODs 130, venue controllers 200, display devices 140, and the like) deployed at the venue.

In one embodiment, at step 320, when a venue is registered with the venue information database 105a, a corresponding entry is made in the content listings database 105b such that content information can be retrieved by individual COD 130 (e.g., where there are multiple CODs deployed at a single venue) and by individual venue 120 (e.g., all content listings for all CODs deployed at a single venue).

At step 330, the venue information server system 100 receives content output information from the CODs 130 and/or the venue controller 200 deployed at the registered venue 120. At step 340, the venue information server system 100 stores the received content output information in the content listings database 105b such that the received content output information is associated with the registered venue 120 from which the content output information was received. Thereafter, the process returns to step 330, such that the content listings database 105b is updated as new content output information is received so that a user 800 (FIG. 8) can determine what content is being shown at a particular venue 120 at any given time.

The flowchart of FIG. 4A shows a process for scheduling content to be displayed by a COD 130 at a particular time. At step 400, venue personnel schedule content to be displayed by one or more CODs 130 deployed at the venue 120. Preferably, schedule information is created and/or updated using the venue controller 200. The scheduling may be for a later time on the same day, or for a different day. For example, venue personnel may want to schedule the venue to show a boxing match that is occurring several weeks later.

Once schedule information is created or updated, at step 410, the schedule information is transmitted to the venue information server system 100 over the network 110. The transmission may occur substantially in real time with the scheduling, or may be periodically transmitted, such as overnight.

The venue information server system 100 causes the schedule information to be stored in the content listings database 105b at step 420. Thereafter, when requested by a user 800, in one embodiment, the schedule information is shown in a content listings grid, such as an electronic program guide. In this case, the user 800 may scroll through the electronic program guide in a chronological manner, or select a desired date and time to see what is scheduled to be shown at the registered venues 120. In another embodiment, the schedule information may be shown as individual schedule entries in a calendar or other view. The process ends at step 430.

FIG. 4B shows a flowchart for updating the content listings database 105b in response to a change in content currently being output by one or more CODs 130. At step 450, content currently being output by one or more content output devices is changed by venue personnel, patrons, or the like. The new content output information is transmitted at step 460 to the venue information server system 100. Preferably, real time content changes are transmitted in real time so that the most up-to-date information on what is currently being shown at a venue is available to patrons and prospective patrons of the venue. The updated content output information is stored in the content listings database 105b at step 470. The process ends at step 480.

Users retrieve content listings from the content listings database 105b by querying the venue information server system 100 over the network 110. FIG. 5 is a flowchart of steps for retrieving content listings according to one preferred embodiment of the present invention. At step 500, a request for listings information is received from a user 800. In the preferred embodiment, the request is transmitted by a user device 810 (FIG. 8) of the user 800, such as a mobile phone, tablet, or the like. The transmitted request preferably includes geographic information (e.g., ZIP code, latitude/longitude, GPS coordinates, wireless network information, or the like) associated with the computing device, or an identification of one or more venues of interest. For example, the user 800 may select one or more venues from a list of venues displayed based on their relative proximity.

At step 510, the venue information server system 100 determines whether the received request includes geolocation information. If the request includes geolocation information, the process proceeds to step 540, where the venue information database 105a is queried to identify one or more registered venues 120 that are in geographic proximity to the geolocation information. Preferably, the distance of geographic proximity is determined based on a number of factors, such as urban or rural setting, as is known to those skilled in the art.

If the request does not include geolocation information, at step 520 the venue information server system 100 determines whether one or more venues have been selected by the request. If so, the process proceeds to step 550, where content listings are retrieved from the content listings database 105b for the selected one or more venues. Otherwise, the process proceeds to step 530, where the venue information server system 100 attempts to identify a location associated with the request, for example by performing an IP Address lookup, retrieving user profile information, or the like. Various techniques for determining geographic location information associated with a request are known to those skilled in the art, and are within the scope of this disclosure.

Once geographic location information has been identified, the process proceeds through steps 540 and 550, as in the case where geolocation information was provided in the request. Finally, at step 560, the retrieved content output listings are provided to the requester over the network 110. The process ends at step 570.

While a user 800 may wish to view television records for venues in a geographic proximity, the user 800 may also wish to locate a venue showing particular content, such as a live sporting event. FIG. 6 is a flowchart of steps for identifying venues showing desired content. The venue information server system 100 receives a request for venues showing specific content at step 600. A user 800 selects the desired content by, for example, selecting from an electronic programming guide or the like, or by entering one or more search terms into a search box.

At step 610, the venue information server system 100 determines geographic location information associated with the request, for example, by retrieving it from the request received at step 600 or by determining it as described with respect to FIG. 5. The venue information server system 100 queries the content listings database 105b to identify one or more venues showing the requested desired content at step 620. The identified venues are sorted at step 630. The identified venues may be sorted based on a number of criteria, for example, based on distance from the geographic location of the requester, venue type, venue popularity, and the like. The sorted list of venues is transmitted to the requester over the network 110 at step 640, and the process ends at step 650.

Referring now to FIG. 7, a sequence diagram of communications between CODs 130 and the venue information server system 100 for registering and updating content output information is shown. At 710, 712, and 714, the CODs 130a, 130b and 130c transmit registration information to the venue information server system 100. At 730, venue information system 100 determines the venues at which the CODs 130 are deployed. At 735, venue information server 100 registers the CODs 130 with the venue information database 105a.

As the CODs 130 output content for display by respective display devices 140, they transmit content output information either directly or through the venue controller 200 to the venue information server system 100 at 740, 750, and 760. Upon receiving the content output information, the venue information server system 100 updates the appropriate entries in the content listings database 105b at 745, 755, and 765.

As shown in FIG. 8, at 820, a user 800 inputs a content output request to the user device 810 by, for example, using a graphical user interface of a mobile application, web application, or the like. In one preferred embodiment, the user 800 specifies a maximum distance of travel for venues to be retrieved. At 830, the user device 810 determines geographic location information associated with the request using, for example, its integrated GPS receiver. At 840, the application on device 810 transmits the request to the venue information server system 100.

At 850, the venue information server system 100 queries the venue information database 105a to identify one or more venues 120 geographically proximate to the location associated with the request. At 860, the venue information server retrieves content listings for CODs 130 deployed at the identified venues 120. The venue information server system 100 transmits the content listings to the user device 810 over the network 110, which are displayed to the user 800 by the user device 810. Preferably, the transmitted content listings are presented by the user device 810 in a graphical user interface such as electronic program guide, calendar, ordered list, or the like. For example, all venues within two (2) miles of the user's user device 810 may be shown to the user 800. The user 800 selects one of the displayed venues to view expanded content listings information. Content listings information shows all content that is currently being shown at the venue. For example, the local sports bar may be showing a PHILADELPHIA PHILLIES baseball game, which would be displayed to the user 800.

FIG. 9 is a sequence diagram of interactions that occur in a preferred embodiment, when the user desires to view specific content. At 910, the user device 810 receives an updated listing of available content choices from the venue information server system 100. At 920, the user device 810 presents the listing to the user 800. At 930, the user selects one or more of the available content choices from the list, or enters a desired search term on the user device 810. For example, if the user wishes to watch a currently playing PHILADELPHIA 76ERS game, the user will select the choice from the graphical user interface or type in “76ers” into a presented search box.

At 940, the user device 810 determines geographic location information associated with the request. At 950, the user device transmits the request to the venue information server system 100. The request preferably includes the selected content identifier and the geolocation information.

At 960, the venue information server system 100 retrieves content listings information from the content listings database 105b. At 970, the venue information server identifies venues showing the desired content. Preferably, the retrieved venues are filtered to only show venues within a pre-specified distance from a desired location. Thus, for example, only venues within two (2) miles of the user device 810 showing the desired 76ERS game will be shown to the user 800. If no entries are found within the desired geographic proximity, a broader geographic range may be searched. Furthermore, the user 800 may wish to limit the venue types being searched in the request. For example, the user 800 may specify that only sports bars showing the desired 76ers game be shown. At 980, the matching venue information is transmitted over the network 110 to the user device 810. At 990, the matching venue information is displayed to the user 800. Therefore, users 800 are able to identify venues that are showing or are scheduled to show desired content without first visiting the venue. In this way, each user 800 is a prospective patron of a venue, and is able to search real time content listings and schedules to determine which venue to visit prior to physically visiting the venue.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for providing venue-specific television programming information for a plurality of venues, the method comprising:
receiving, over a first network, from a plurality of content output devices, identifying information associated with the content being output or scheduled to be output by the content output devices deployed at the plurality of venues;
updating the venue entries stored in the venue database with the received identifying information associated with content being output or scheduled to be output by the content output devices deployed at the respective venues;
receiving, from a device associated with a user, a request for content listings, the request comprising information regarding the location of the user;
determining content listings based upon the information regarding the location of the user and the updated information associated with the content being output or scheduled to be output by the content output devices deployed at the plurality of venues; and
transmitting the determined content listings to the device associated with the user.

2. The method of claim 1 wherein information regarding the location of the user is determined by an application on the device associated with the user.

3. The method of claim 1 wherein information regarding the location of the user is determined based upon information provided by the user.

4. The method of claim 1 wherein the request for content listings comprises an indication of content the user wishes to view at a venue.

5. The method of claim 1 further comprising:
transmitting a list of content choices to the device associated with the user prior to receiving the request for content listings.

6. The method of claim 1 wherein the request for content listings comprises a request for content being displayed at one or more venues.

7. The method of claim 6 wherein the one or more venues are selected automatically based upon the information regarding the location of the user.

8. A system for disseminating venue-specific content output information to users, the system comprising:
(a) a venue database storing a plurality of venue entries associated with a respective plurality of venues, each venue entry comprising or being associated with information identifying one or more content output devices deployed at the venue, each of the content output devices configured to output content to users at the venue;
(b) a controller communicatively coupled to the content output devices by a first network, the controller configured to:
(i) receive, over the first network, from the content output devices, identifying information associated with the content currently being output or scheduled to be output by the respective content output devices deployed at the plurality of venues, and
(ii) cause the venue entries stored in the venue database to be updated with the received identifying information associated with the content currently being output or scheduled to be output by the content output devices deployed at the respective venues; and
(c) a server accessible by a plurality of devices associated with users, over a second network, from locations other than the plurality of venues, to provide the identifying information stored in the venue database, the identifying information allowing the respective users to determine content currently being output or scheduled to be output at one or more of the plurality of venues.

9. The system of claim 8 wherein the first network and the second network are the same network.

10. The system of claim 8 wherein the controller is a central server system.

11. The system of claim 8 wherein at least one controller is co-located at a venue with the content output devices deployed at the venue, and the controller is communicatively coupled to the server.

12. The system of claim 8 wherein the content output device is a set-top box.

13. The system of claim 8 wherein the content output device is a television.

14. The system of claim 8 wherein the controller is further configured to receive, from a device associated with a user, a request for content listings comprising information regarding the location of the user, wherein the information regarding the location of the user is determined by an application on the device associated with the user.

15. The system of claim 14 wherein information regarding the location of the user is determined based upon information provided by the user.

16. The system of claim 14 wherein the request for content listings comprises indication of content the user wishes to view.

17. The system of claim 14 wherein the request for content listings comprises a request for content being displayed at one or more venues.

18. The method of claim 17 wherein the one or more venues are selected automatically based upon the information regarding the location of the user.

19. A system for disseminating venue-specific television programming information to users, the system comprising:
(a) a venue database storing a plurality of venue entries associated with a plurality of venues, each venue entry including information identifying one or more set-top boxes deployed at the venue, each of the set-top boxes configured to output content at the venue through respective communicatively coupled display devices;
(b) a controller communicatively coupled to the set-top boxes by a first network, the controller configured to:
(i) receive, over the first network, from the set-top boxes, identifying information associated with the content to be output by the respective set-top boxes deployed at the plurality of venues, and
(ii) cause the venue entries stored in the venue database to be updated with the received identifying information of content to be output by set-top boxes deployed at the respective venues; and
(c) a server accessible by computing devices of users over a second network to retrieve the identifying information stored in the venue database, the identifying information allowing the respective users to determine content to be output at venues of interest prior to physically visiting the venues.
